(19) United States
(12) Patent Application Publication
(10) Pub. No.: US 2011/0191170 A1
(43) Pub. Date: Aug. 4, 2011

(54) SIMILARITY FUNCTION IN ONLINE ADVERTISING BID OPTIMIZATION

(75) Inventors: Ruofei Zhang, San Jose, CA (US); Ying Cui, Sunnyvale, CA (US)

(73) Assignee: Yahoo! Inc., Sunnyvale, CA (US)

(21) Appl. No.: 12/698,463

(22) Filed: Feb. 2, 2010

(51) Int. Cl. G06Q 30/00; G06F 15/18

(52) U.S. Cl. 705/14.46; 706/12

(57) ABSTRACT

The present invention provides methods and systems for use in bid optimization in connection with advertisement serving impression opportunities available in an auction-based online advertising exchange. Methods are presented in which, based in part on historical advertisement performance information, a Kalman filter-based model is used in forecasting performance of a set of possible advertisement impressions served over a future period of time. Forecasted performance information is used in determining an optimized bid in connection with an available opportunity. A similarity function, including non-linearly determined feature weighting, can be used in determining most similar forecasted impressions to the available opportunity.

### BACKGROUND

An auction-based online advertising exchange can bring together networks of parties including publishers and advertisers as well as facilitator and intermediary entities. In such an exchange, future or anticipated advertisement serving opportunities, or equivalents thereto, may be purchased in an auction-based online marketplace. Purchasing parties can include advertisers as well as other entities, such as intermediary entities that may, after purchasing impression opportunities, sell them to advertisers or other parties.

Determining optimal bidding in connection with available advertisement serving opportunities, while of critical importance, is not a simple task. The value of a to-be-served impression depends on its forecasted performance, which in turn depends on many variables that together can be termed a target profile associated with the impression. Target profile variables, or features, can include characteristics or parameters associated with the advertisement, the associated publisher Web page, and user characteristics, as well as the time or period of serving.

The computationally complex problem of determining an optimized bid for an available advertisement serving opportunity is made all the more challenging due to the fact that target profile information relating to the opportunity may only be available a very short time, even down to a fraction of a second, prior to purchase.

As such, rather than attempt to individually compute the value of a particular available serving opportunity very quickly, offline data, such as tables, may be compiled used as a quick way determine an optimized bid in connection with a particular opportunity. For example, a table may be compiled with forecasted revenue-related performance information, such as RPM (revenue per million impressions) information, relating to a large number of different possible individual advertisement serving opportunities, in association with features associated with each opportunity. Historical performance information associated with actually served advertisement impressions can be used in determining the forecasted performance information. The forecasted performance information can be used in determining an optimized bid.

However, accurately forecasting such performance information, even offline, remains a difficult and computationally complex problem. Furthermore, an additional problem concerns how to efficiently and accurately identify one or more particular forecasted impressions best suited for use in forecasting the performance of an available advertisement serving opportunity.

There is a need for methods and systems for use in performance forecasting and bid optimization in connection with advertisement serving opportunities available through an online advertising exchange.

### SUMMARY

Some embodiments of the invention provide methods and systems for use in bid optimization in connection with advertisement impression serving opportunities available through an auction-based online advertising exchange. Methods are presented in which, based in part on historical advertisement performance information, a Kalman filter-based model is used in forecasting performance of a set of possible advertisement impressions served over a future period of time. In some embodiments, a performance measure, such as RPM, is modeled over time in the Kalman filter-based model as an object in free motion.

In some embodiments, forecasted performance information for a set of possible advertisement impressions served over a future period of time is used in determining an optimized bid in connection with an available opportunity. A similarity function, including non-linearly determined feature weighting relative to individual features, can be used in determining most similar forecasted impressions to the available opportunity for the purpose of determining an optimized bid in connection with the available opportunity. In some embodiments, a decision tree-based approach is used in the similarity determination, such as a decision tree approach using a gradient boosting technique.

In some embodiments, to limit the set of forecasted possible advertisement impressions analyzed or scanned using the similarity function, an optimized subset of the set of possible advertisement impressions is first selected, based at least in part on determined similarity and confidence measures. The similarity function can then be used in connection with each one of the optimized subset, to determine a most similar one for the purpose of bid optimization relative to the available opportunity.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention; and

FIG. 4 is flow diagram illustrating a method according to one embodiment of the invention;

FIG. 5 is a flow diagram illustrating a method according to one embodiment of the invention; and

FIG. 6 is flow diagram illustrating a method according to one embodiment of the invention.

### DETAILED DESCRIPTION

Some embodiments of the invention use a Kalman filter-based model in forecasting performance of a set of possible advertisement impressions served over a future period of time. In some embodiments, a performance measure or parameter, such as RPM, is modeled over time in the Kalman filter-based model as an object in free motion, such as an object in motion in a two-dimensional space. Furthermore, some embodiments include modeling a change in the performance parameter over time as a change in velocity of the object in free motion.

In some embodiments, a large number of features associated with a target profile can each be modeled as an object in free motion, although ultimately the modeling can lead to a single forecasted RPM associated with the target profile. In some embodiments, historical advertise ent performance information, including RPM information in connection with impressions with various features, is used as input to the model. In some embodiments, the model is used as part of or with one or more machine learning techniques, such as feature-based machine learning techniques.

Generally, Kalman filters, or Kalman filter models, often used in signal processing applications, can be used for purposes including modeling a discrete time-dependent state process with measurement subject to a noise condition. Kalman filters can be used to model free motion when a control signal does not exist.

In some embodiments of the invention, a daily or other time-based change in RPM for each bid profile is modeled as random motion with a fault tolerant measurement. In some embodiments, a Kalman filter is used in prediction, recursively using previous a posteriori estimates or forecasts to project or predict new a priori estimates or forecasts. The Kalman gain can adjust the weighting between a previous estimate and a true measurement, or actual RPM.

In some embodiments, RPM daily change is modeled as free motion. A state vector can be set up as Xₖ=[sxₖ vxₖ]^{T}, where sx models the RPM value and vx models the velocity of RPM value change.

In some embodiments, a central equation of the Kalman filter model is:

$${X}_{k} = {AX}_{k - 1} + {W}_{k - 1} , {z}_{k} = {HX}_{k} + {v}_{k} , A = [ \begin{matrix}1 & 1 \\ 0 & 1\end{matrix} ] , \\ H = [ \begin{matrix}1 & 0 ]\end{matrix} \qquad ( Eq . 1 )$$

In some embodiments, a forecasting central equation of the model is:

sxₖ=sxₖ₋₁+vxₖ₋₁+wₖ₋₁, vxₖ=vxₖ₋₁+wₖ₋₁ (Eq. 2)

Here, zₖ=rpmₖ=sxₖ+vₖ, i.e., the actual RPM is the measurement.

In some embodiments, a model can be applied in RPM prediction or forecasting that includes three steps, including (1) initialization, (2) prediction and model update, and (3) correction for the next prediction.

An initialization step can include the following.

$${\overline{X}}_{0}^{\hat{}} = {rpm}_{0} , {\overline{P}}_{0} = {\overline{P}}_{0} = [ \begin{matrix}1 & 0 \\ 0 & 1\end{matrix} ] , Q = [ \begin{matrix}0.5 & 0 \\ 0 & 0.5\end{matrix} ] , R = 0.5$$

In some embodiments, a prediction and model update step can include the following. X̂⁻ₖ=X̂⁻ₖ₋₁ can represent prediction for today's RPM state. Pₖ⁻=APₖ₋₁A^{T}+Q can represent prediction of an error covariance matrix.

In some embodiments, a step of correction for the next prediction can include the following. Kₖ=Pₖ⁻H^{T}(HPₖ⁻H^{T}+R)⁻¹ can represent adjusting Kalman gain. X̂ₖ=X̂⁻ₖ+Kₖ(zₖ−HX̂⁻ₖ) can represent computing a post state, so as to prepare for tomorrow's estimate or prediction. Pₖ−(I−KₖH)P⁻ₖ can represent computing posterior error covariance.

In the above, the first and second steps can run iteratively as “Prediction” and “Correction” for time update and measurement update. When the error covariance approaches 0, the weighting factor Kalman gain K weights the actual measurement zₖ more. When the a priori estimate error covariance P⁻ₖ approaches 0, zₖ is weighted less. In addition, the Kalman filter is insensitive of initialization of X̂⁻₀, while good initial states can lead to small delay in tracking the motion, and bad initial states can result in a longer delay for the model to catch up with the motion under prediction.

The above specifics in connection with a Kalman filter-based model are merely illustrative, and many other embodiments are contemplated.

In some embodiments, a Kalman filter-based model can be used offline for generation of forecasted impression and associated performance, such as RPM, forecasting information. This forecasting information may be used in forming data structures such as tables. Later, during an online auction, when a target profile becomes available, in association with an available advertisement impression serving opportunity, the forecasting information can be used in determining a predicted or forecasted performance, such as RPM, associated with the available opportunity. That can then be used in determining an optimal bid (if any bid is warranted) on the available opportunity.

However, with an online auction, a bid may need to be determined and submitted in real-time or near real-time, such as in a small fraction of a second. It may be impractical or impossible to determine a most closely matching forecasted impression from scanning or analysis of all of the forecasting information and all of the forecasted impressions, in such a short time frame. As such, in some embodiments of the invention, a subset of the forecasting information is selected offline. Online, only the subset may be subject to scanning or analysis, such as by use of a similarity function according to an embodiment of the invention. In some embodiments, the scanning or analysis may include using a machine learning technique and a similarity function to determine which forecasted impression of the subset is most similar to an available opportunity, for the purpose of revenue forecasting and bid optimization with regard to the opportunity. The subset may be chosen to be an appropriate or optimal size. Furthermore, each forecasted impression of the subset may be chosen based on associated aspects such as determined coverage and confidence measures associated with the forecasted impression.

Some embodiments of the invention include application of a machine learning technique and similarity function in connection with an online advertising exchange. As such, some embodiments described below include description relating to the advertising exchange context.

In an advertising exchange, a bidding agent, such as a partially or fully automated bidding agent, can participate in the exchange to bid on real-time or near real-time available impression supplies with different attribution granularities. Each impression may be called a target profile. Each profile may have a number of attributes or features, including attributes of an associated page and user, such as page domain, advertisement size, and targeting aspects. The objective of the agent may be, given a target profile, to decide whether to bid, and if so, an optimized bid value and forecasted payout or revenue, which can include a minimal payout. In some approaches, a bid index (serialized a key-value pairs) is generated daily by offline modeling and loaded into an online serving system, which can be called a Generic Data Service, or GDS. Each entry in the GDS can be a tuple (target profile id, regular bid value, learning bid value, learning probability). In online serving, the incoming target profile may be looked up in GDS, and corresponding values returned for use in real time bidding.

In some contexts in which embodiments of the invention can be practiced, one of the metrics of the agent can be the bid coverage, which can be defined, for example, as the percentage of the target profiles for which there is a match in GDS. To increase the coverage, besides exact match of a target profile, one also needs to support similar target profiles matching. A similar target profile set can be called templates. Similar target profiles can be those target profiles in one template that have some common attributes with the incoming target profile and that also have similar performance, such as RPM or eRPM. As such, a problem that can need to be addressed is to find an optimal similarity function which can allow measurement of the similarity between a target profile and a template, or members thereof, such that, for example, the higher similarity score, the more similar of the target profile performance.

In some contexts in which embodiments of the invention can be practiced, a forecast/bid tree (called star tree), which can be decision tree based, is used to generate the bid index. The tree can be formed from forecasted impression and associated performance information.

In some contexts, each target profile is defined by a unique combination of, for example, fifteen attribute values, including source tag, page domain, user geo location, ad size, user age, gender etc. As such, length of any path from the root to the leaf nodes in such a star tree is fifteen. Each level in the tree can be viewed as corresponding to what can be called a target dimension. Every leaf node in the tree can store the bid value for the target profile defined by the path from the root of the tree.

However, the tree size can be huge because there are very many possible combinations of target dimension values. For example, suppose one only has three target dimensions which can be, for illustrative purposes, source tag, geo and domain. There are about 5,000 possible source tags, fifty US states and more than 5,000 unique domains. As such, the number of possible target profiles will be 5,000*50*5,000. Even after, for example, rolling up those paths with less than 1,000 impressions less, one still has 50,000 to 80,000 different paths in the forecast/bid tree every day. As such, one challenge can be, when the new target profiles comes, determining the most similar path to get the bid value at real time or near real time, and at the same time maintain high coverage (which can mean or include, for example, having a low no-bid rate). In some contexts, for an incoming target profile, an agent will dispatch attribute masked (materialized) templates as well as the incoming target profile in one call to GDS to get all the matched target profiles back. Following this, in some embodiments, a defined similarity function can be used in determining the similarity between the incoming target profile and all returned target profiles. The target profile with the highest similarity score can be used in determining an optimal bid. Some embodiments of the invention provide a machine learning approach to learn an optimal implementation of such a similarity function.

Some particular embodiments of the invention are described as follows, although many other embodiments are possible and contemplated. In some contexts, every day, there are many new target profiles coming, and one may not have an exact match path to pick. Therefore, some embodiments use the concepts of exact match (“v” match), question mark match (“?” match) and star match (“*” match).

The “v” match is exact match, i.e., the target dimension value is exactly the same as in the tree path.

The “?” match stands for “others”, which can mean that there is no exact value in the specific target dimension level equal to the new input target value. “?” match may typically happen on those target profiles carrying small traffic. During a rollup phase, if the impressions of some target dimensions are small (for example, fail to pass a 1,000 impression threshold), they may be rolled up to be a “?” node. For more prominent target profiles, there is more likely to be an exact match in the tree. The “*” match means “all”. “*” nodes may be kept at each level, which carry the aggregated average for all the possible attribute values. As for priority in terms of similarity closeness, and in terms of use, a “v” match is better than than a “?” match, and a “?” match is better than a “*” match.

The system of match types described herein can be used, in some embodiments, in dealing with the problem of target profiles for which there is no exact match in the tree.

A next step can include how to pick the matching path at run time. Note that at each target dimension, there three possible matches based on the three different match types described herein. That would mean that, for the 15 attributes, one would have 3¹⁵=14,348,907 possible matching paths. In the worst case, one would need to analyze or scan all of these possible match paths to find and pick the right one. That can be impractical to implement in the front end.

Thus, it can be very important to find a reasonably or optimally sized template set prior. Furthermore, it can be important to choose a good or optimal set. In some embodiments, an optimal set is chosen based on aspects including similarity and coverage relative to anticipated impression opportunities.

There can be two subtasks involved in solved a similar path lookup problem. One is pick an optimal template set with a moderate size. In some embodiments, this is performed periodically, such as once a month, including updated information each time. For example, one can use one month's target profiles as training data to get 30 optimal templates. The second is to pick an optimal or best template from the optimal template set to support run time fast lookup so as to get an optimized bid value.

An objective of optimal template set generation, according to some embodiments, can be described in the following function:

arg max(T)={Σₜₚ[α*tan h(sim(T,tp))+(1−α)*conf(Tₘ)]}, where (Eq. 3)

conf(Tₘ)=tan h{a log(eWonImp_{Tm})+b},

where T is template and tp is target profile, and Tₘ, is the output of masking the target tp with the template T; α is configurable. a and b are model parameters that need to be tuned. In some embodiments, this objective function (Eq. 3), reflects the fact that it is desired to have those templates that have high similarity plus high confidences over all target profiles.

In some embodiments, for the similarity function, sim(T,tp), it is formalized as a regression-type problem in which the target is true RPM of each target profile. In embodiments using the star tree structure, above, one has three types of matches for each attribute. They are “v”, “?” and “*” match. One can then construct new features to learn an implementation of the similarity function based on different matching schema.

For example, assuming there are 15 attributes, a₁, a₁, . . . , a₁₅, they can be transformed into 45 new features, f₁ᵥ, f_{1?}, f₁*, . . . , f₁₅ᵥ, f_{15?}, f₁₅*. Each new feature represents the match type at each attribute. The similarity function, which becomes:

=Σ(i=1 to 15){cᵢ₁,fᵢᵥ+cᵢ₂,f_{1?}+cᵢ₃,fᵢ*} (Eq. 4)

is casted to a linear regression problem. The objective function to minimize is the least square error of RPM. One then only needs to learn the weight of each extracted feature using training data, which can include historical advertisement serving impression information. Each target profile can then be masked to all possible templates, if the output exists as a path in the star tree. One can then get a training sample with this path and the corresponding RPM. One can then use gradient descent boosting tree to train the similarity function which maps the input of the 45 attributes to the true RPM. By training from (target profile, true RPM) pairs, one can, in a nonlinear fashion, get the importance weight of each attribute in prediction of RPM, thus deriving the closed form of sim(T,tp). Of course, many other embodiments are possible.

In some embodiments, the confidence function, conf(Tₘ) is a monotonically increasing function in the form of hyperbolic tangent. After the target profiles mask to the template, the estimated won impression (eWon Im p) of the output Tₘ can be evaluated to get the confidence score. A high estimated won impression indicates that one has a high confidence in relation to the performance of this template. Because the eWon Im p could be very large, some embodiments include taking the logarithm of the raw input. In some embodiments, in order to combine the confidence score with the similarity score, one needs to normalize them to the same scale. Thus, one can further take the hyperbolic tangent to set their range from −1 to +1.

In some embodiments, the best template set is composed of the first several templates with the highest score in Eq. 3, i.e., the highest similarity combined with confidence score. The confidence function is relative easy to tune.

After the optimal template set is constructed, in run time, one matches the incoming target profiles with all the templates selected as optimal. The star tree is then queried with all the matching output, and it will return all the existing paths and bid value. Then the path with the highest score of Eq. 3 is selected, and its bid value is used for the target profile to bid. For example, suppose one has 30 templates in the optimal template set. One masks a coming target profile with all of them to get 30 paths. All 30 paths are queried and 12 of them exist and each returns a bid value. The final score described in Eq. 3 is then computed for the 12 output paths. The bid value of the path with the highest score is the target hid selected for the incoming target profile. In some embodiments, this approach solves the problem of real-time lookup for the optimal path in the star tree.

In some contexts, another problem that can exist is data sparsity and, in consequence, high variance of the measured RPM at different bid ranges for one target profile. There may be RPMs of two granularities, specifically, target profile level and (target profile, bid range) level. The coarser the granularity, the more mild the data sparsity issue but the more bias the measured RPM. This is an example of the notorious bias-variance problem.

In some embodiments, to address this problem, a modified backoff version of a Jelinek-Mercer technique is used prior to smooth RPM estimation. In such embodiments, if the won impression of a bid range in target profile j is high enough (greater than a threshold), measured (target profile, bid range) level RPM is used. Otherwise, back-off is performed to use target profile level RPM as prior to smooth the bid range level RPM. In this way, there is less bias when the data sparsity problem is not severe, but when data sparsity is serious, a smoothed RPM estimation technique can be used to reduce the RPM variance.

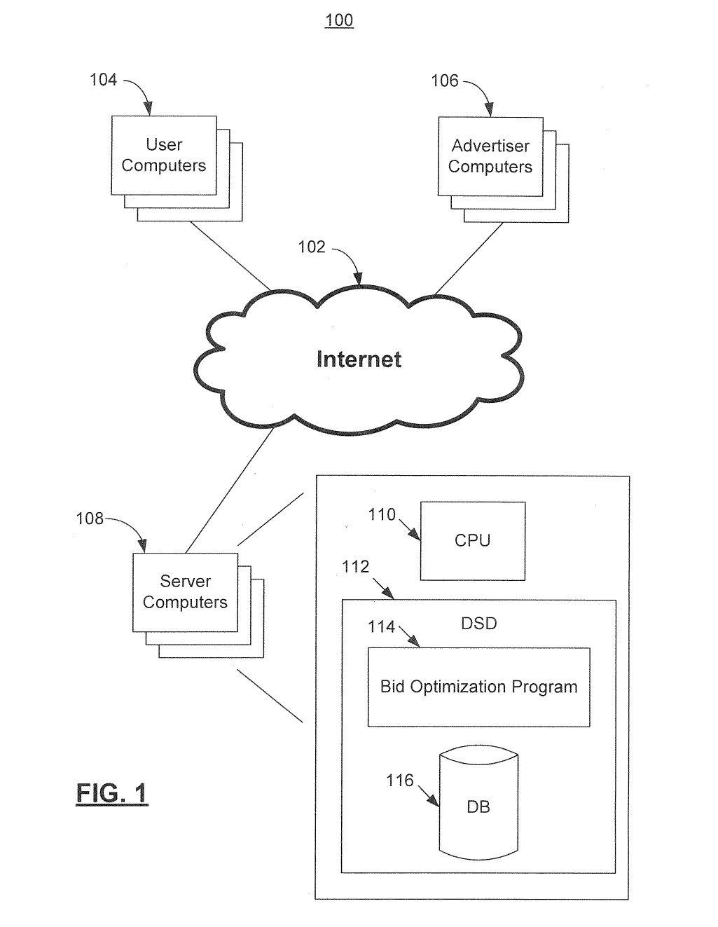

FIG. 1 is a distributed computer system 100 according to one embodiment of the invention. The system 100 includes user computers 104, advertiser computers 106 and server computers 108, all coupled or coupleable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, programs, algorithms and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results and advertising, such as graphical or banner advertising as well as keyword searching and advertising in a sponsored search context.

As depicted, each of the server computers 108 includes one or more CPUs 110 and a data storage device 112. The data storage device 112 includes a database 116 and a bid optimization program 114.

The program 114 is intended to broadly include all programming, applications, software, algorithms and other and tools necessary to implement or facilitate methods and systems according to embodiments of the invention. The elements of the program 114 may exist on a single computer or device, or may be distributed among multiple computers or devices.

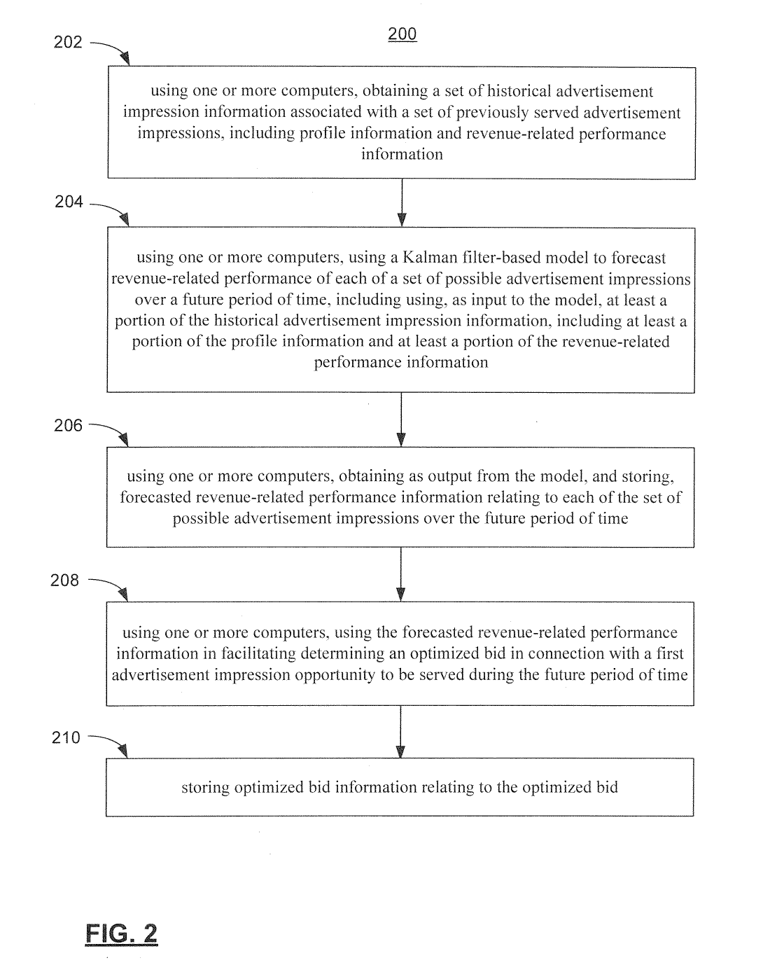

FIG. 2 is a flow diagram illustrating a method 200 according to one embodiment of the invention. At step 202, using one or more computers, a set of historical advertisement impression information is obtained. The information is associated with a set of previously served advertisement impressions and includes profile information and revenue-related performance information.

At step 204, using one or more computers, a Kalman filter-based model is used to forecast revenue-related performance of each of a set of possible advertisement impressions over a future period of time, including using, as input to the model, at least a portion of the historical advertisement impression information, including at least a portion of the profile information and at least a portion of the revenue-related performance information.

At step 206, using one or more computers, forecasted revenue-related performance information relating to each of the set of possible advertisement impressions over the future period of time is obtained as output from the model and stored.

At step 208, using one or more computers, the forecasted revenue-related performance information is used in facilitating determining an optimized bid in connection with a first advertisement impression opportunity to be served during the period of time.

At step 210, optimized b d information relating to the optimized bid is stored.

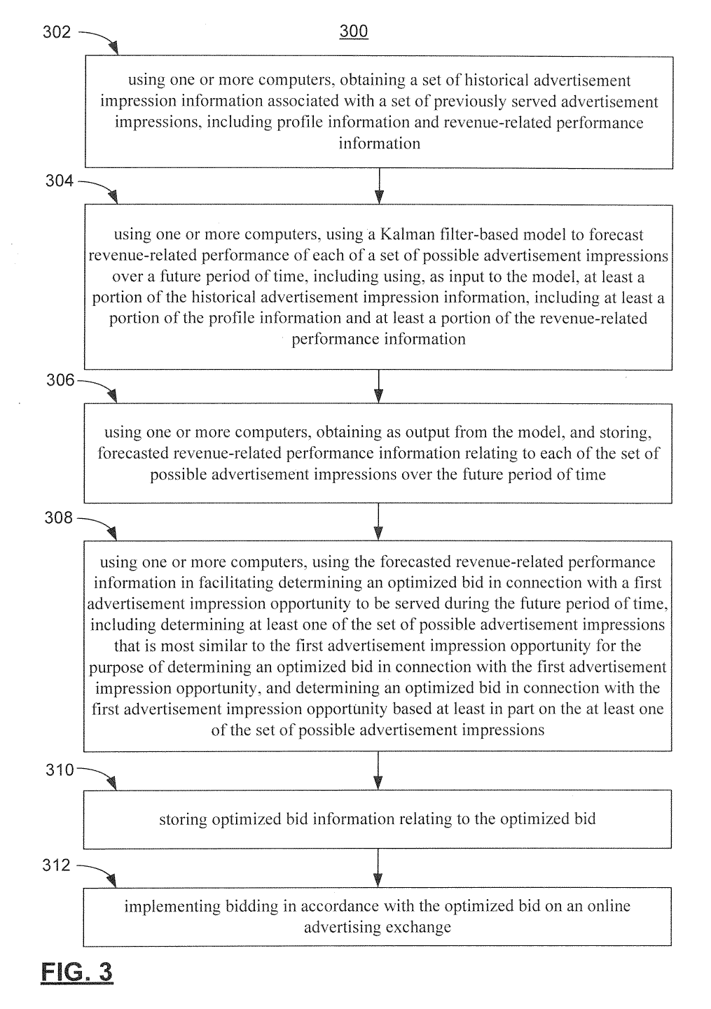

FIG. 3 is a flow diagram illustrating a method 300 according to one embodiment of the invention. Steps 302, 304 and 306 are similar to steps 202, 204 and 206 as depicted in FIG. 2.

At step 308, using one or more computers, the forecasted revenue-related performance information is used in facilitating determining an optimized bid in connection with a first advertisement impression opportunity to be served during the period of time. Step 308 includes determining at least one of the set of possible advertisement impressions that is most similar to the first advertisement impression opportunity for the purpose of determining an optimized bid in connection with the first advertisement impression opportunity. Step 308 further includes determining an optimized bid in connection with the first advertisement impression opportunity based at least in part on the at least one of the set of possible advertisement impressions.

At step 310, optimized bid information relating to the optimized bid is stored.

At step 312, bidding in accordance with the optimized bid is implemented on an online advertising exchange.

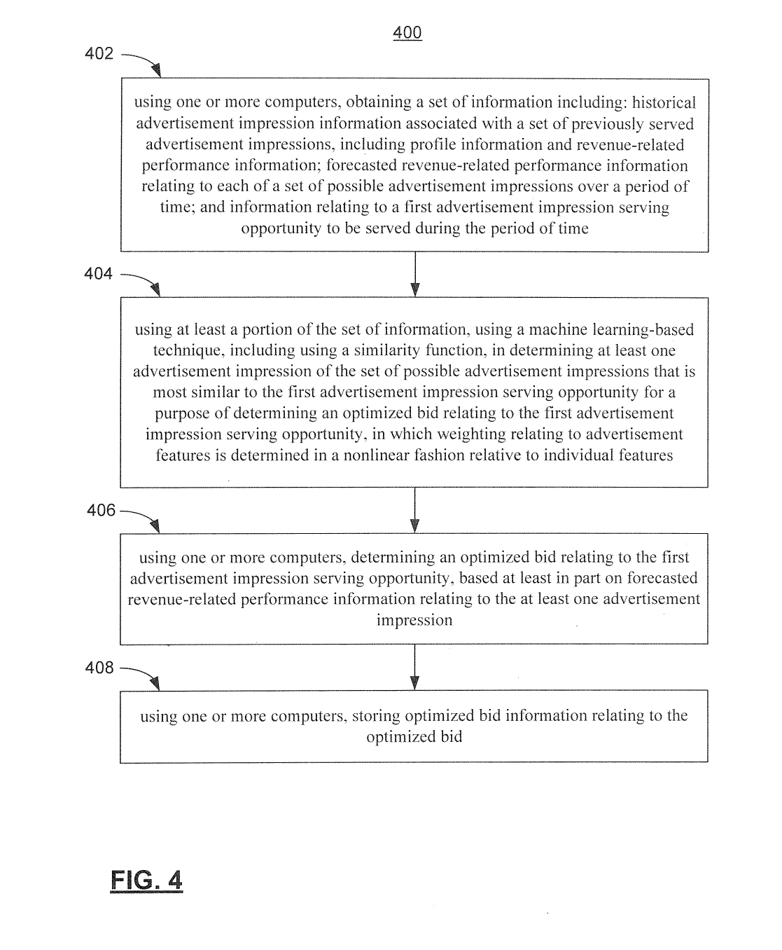

FIG. 4 is flow diagram illustrating a method 400 according to one embodiment of the invention. Step 402, using one or more computers, a set of information is obtained. The set of information includes historical advertisement impression information associated with a set of previously served advertisement impressions, including profile information and revenue-related performance information. The set of information further includes forecasted revenue-related performance information relating to each of a set of possible advertisement impressions over a period of time. The set of information further includes information relating to a first advertise impression serving opportunity to be served during the period of time.

At step 404, using at least a portion of the set of information, a machine learning-based technique is used, including using a similarity function, in determining at least one advertisement impression of the set of possible advertisement impressions that is most similar to the first advertisement impression serving opportunity for a purpose of determining an optimized bid relating to the first advertisement impression serving opportunity. Weighting relating to advertisement features is determined in nonlinear fashion relative to individual features.

At step 406, using one or more computers, an optimized bid is determined, relating to the first advertisement impression serving opportunity, based at least in part on forecasted revenue-related performance information relating to the at least one advertisement impression.

At step 408, using one or more computers, optimized bid information is stored, relating to the optimized bid.

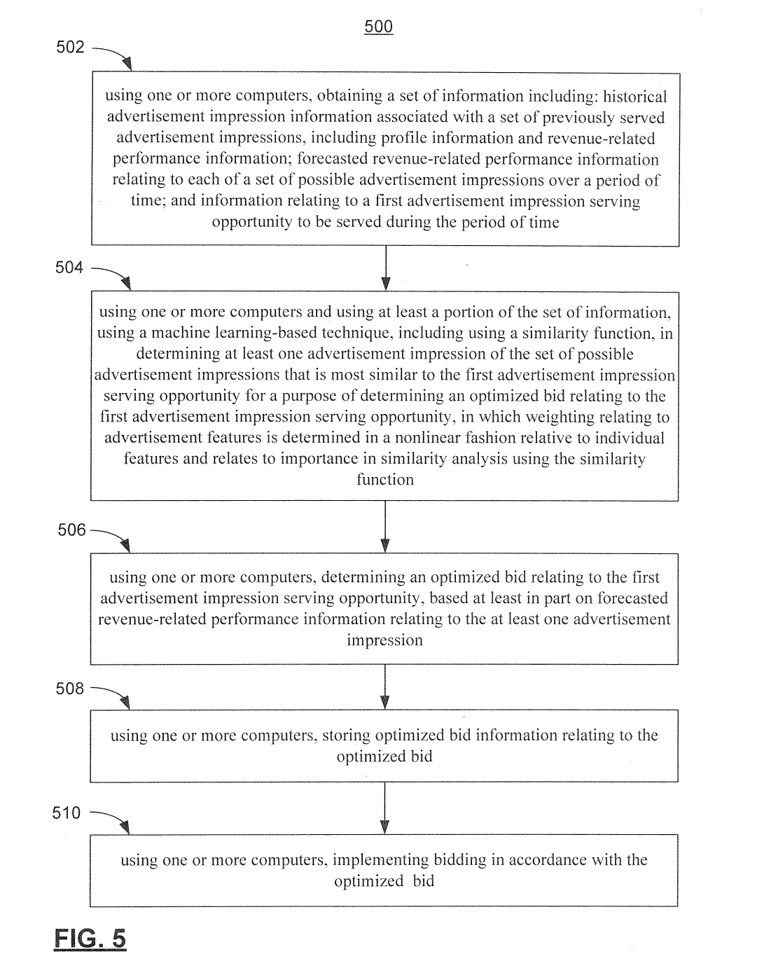

FIG. 5 is a flow diagram illustrating a method 500 according to one embodiment of the invention. Step 502 is similar to step 402 as depicted in FIG. 4.

At step 504, using one or more computers and using at least a portion of the set of information, a machine learning-based technique is used, including using a similarity function, in determining at least one advertisement impression of the set of possible advertisement impressions that is most similar to the first advertisement impression serving opportunity for a purpose of determining an optimized bid relating to the first advertisement impression serving opportunity. Weighting relating to advertisement features is determined in a nonlinear fashion relative to individual features and relates to importance in similarity analysis using the similarity function.

Steps 506 and 508 are similar to steps 406 and 408 as depicted in FIG. 4.

At step 510, using one or more computers, bidding is implemented in accordance with the optimized bid.

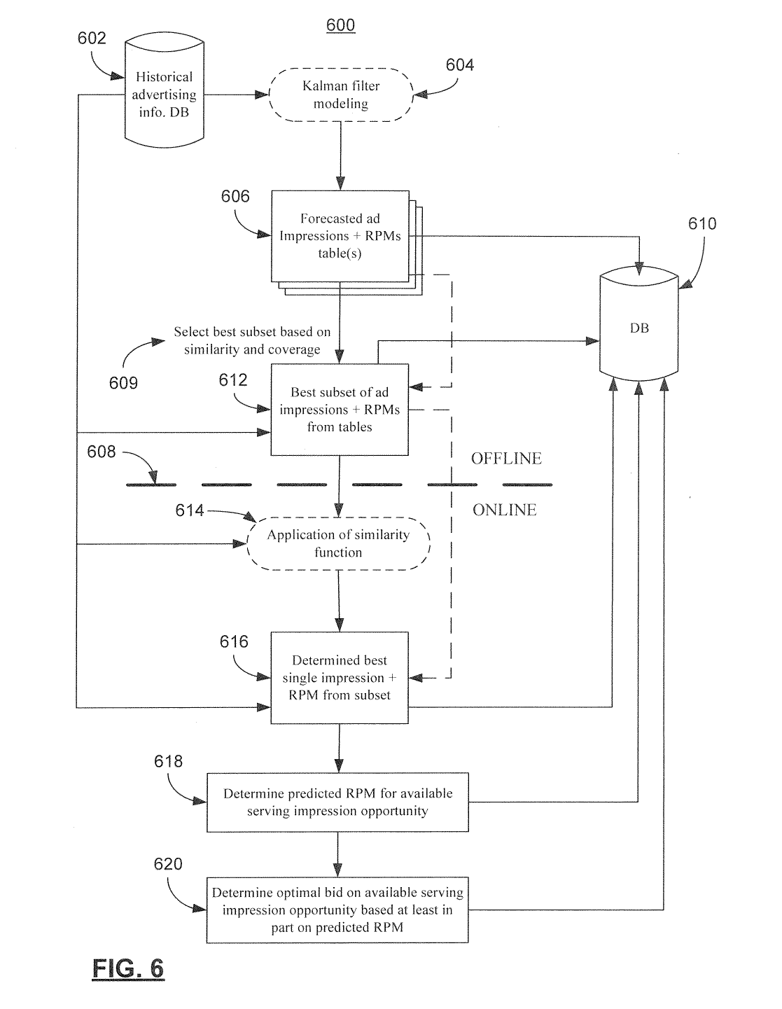

FIG. 6 is flow diagram illustrating a method 600 according to one embodiment of the invention.

At step 604, a Kalman filter-based modeling technique is used. More specifically, information from a historical advertising information database 602 is used as input to a Kalman filter-based model. The information can include a set of historical advertisement impression information associated with a set of previously served advertisement impressions, including profile information and revenue-related performance information.

The modeling technique outputs information from which one or more tables 606 can be generated, including thr casted advertisement serving impressions and associated forecasted advertisement performance information, such as RPM associated with each impression. The tables 606 are stored in a database 610.

Following this, selection 609 is made of a best subset 612 of forecasted advertisement impressions and associated RPM information, from the tables 606. Information regarding the subset may be stored in one or more tables. The subset 612, or tables including the information relating thereto, is stored in the database 610. In some embodiments, selection of a relatively small subset 612 of forecasted impressions from the tables 606 enables or facilitates much faster determination, in real time or near real time, when information becomes available on an available advertisement serving impression opportunity, of a most similar forecasted impression. In some embodiments, the subset 612 is optimized or determined based on factors including size as well as a scope of coverage and a confidence level associated with impressions of the subset relative to possible available serving impression opportunities. Furthermore, the size of the subset 612 may be determined so as to be reasonable or optimal with respect to completeness and practicality, and possibly other factors.

Input to step 612 can include a set of information including historical advertisement impression information associated with a set of previously served advertisement impressions, including profile information and revenue-related performance information. The set of information can also include forecasted revenue-related performance information relating to each of a set of possible advertisement impressions over a period of time. The set of information can also include information relating to a first advertisement impression serving opportunity to be served during the period of time.

As represented by broken line 608, in some embodiments, steps up to step 612 may be performed offline or otherwise not in connection with or driven by time constraints related to an online auction, such as a real-time or near real-time auction. Step 614 and subsequent to steps, on the other hand, may be performed during an online auction.

In some embodiments, the subset 612 of forecasted impressions is used during an online auction. Specifically, when information becomes available regarding a particular first advertisement impression serving opportunity, such as in real-time or near real-time, a determined best or most similar forecasted impression from the subset 612 may determined for the purpose of determining an optimal bid with regard to the first advertisement impression serving opportunity. More specifically, at step 614, a similarity function according to an embodiment of the invention is used in determining the best or most similar forecasted impression from the subset 612, as represented by step 616. In some embodiments, a machine learning technique and the similarity function are used, and weighting relating to advertisement features is determined in a nonlinear fashion relative to individual features. The best or most similar forecasted impression is stored in the database 610.

At step 618, a predicted performance measure, such as RPM, is determined for the first advertisement impression serving opportunity and stored in the database 610.

At step 620, an optimal hid (or no bid) is determined on the first advertisement impression serving opportunity based at least in part on predicted RPM associated with it. The optimal bid (which can include a range, and can include various information associated therewith) is stored in the database 610.

Although not depicted in FIG. 6, in some embodiments, following step 620, bidding is facilitated or implemented in accordance with the optimal bid.

The foregoing description is intended merely to be illustrative, and other embodiments are contemplated within the spirit of the invention.

1. A method for use in association with an auction-based online advertising exchange, the method comprising:
using one or more computers, obtaining a set of information comprising:
historical advertisement impression information associated with a set of previously served advertisement impressions, comprising profile information and revenue-related performance information;
forecasted revenue-related performance information relating to each of a set of possible advertisement impressions over a period of time; and
information elating to a first advertisement impression serving opportunity to be served during the period of time;
using one or more computers and using at least a portion of the set of information, using a machine learning-based technique, comprising using a similarity function, in determining at least one advertisement impression of the set of possible advertisement impressions that is most similar to the first advertisement impression serving opportunity for a purpose of determining an optimized bid relating to the first advertisement impression serving opportunity, wherein weighting relating to advertisement features is determined in a nonlinear fashion relative to individual features;
using one or more computers, determining an optimized bid relating to the first advertisement impression serving opportunity, based at least in part on forecasted revenue-related performance information relating to the at least one advertisement impression; and
using one or more computers, storing optimized bid information relating to the optimized bid.

2. The method of claim 1, wherein determining weighting comprises determining weighting with respect to importance in similarity analysis.

3. The method of claim 1, in which weighting is determined based at least in part on performance parameters associated with combinations of individual features.

4. The method of claim 1, wherein determining the weighting comprises determining weighting with respect to importance in similarity analysis using the similarity function, and wherein weighting is determined in a nonlinear fashion relative to individual features, and comprising using the weighting in obtaining coefficients for terms including in the similarity function.

5. The method of claim 1, wherein using the similarity function comprises using a similarity function in which terms are linear with respect to individual features, and in which weighting coefficients associated with the terms are derived in a nonlinear fashion with regard to individual features, including taking into account performance in connection with combinations of individual features.

6. The method of claim 1, comprising selecting an optimized subset, of the set of possible advertisement impressions, for analysis using the machine learning-based technique, comprising using the similarity function in determining at least one advertisement impression of the subset of possible advertisement impressions that is most similar to the first advertisement impression serving opportunity for a purpose of determining an optimal bid relating to the first advertisement impression serving opportunity.

7. The method of claim 6, comprising selecting the subset of the set of possible advertisement impressions, for analysis using the machine learning-based technique, based at least in part on, with respect to a target profile set, and for each member of the set, a confidence measure and a similarity measure.

8. The method of claim 1, wherein using the machine learning-based technique, including the similarity function, includes using a feature-based decision tree.

9. The method of claim 8, wherein using the machine learning-based technique, including the similarity function, includes using a feature-based decision tree technique including a gradient boosting technique.

10. The method of claim 1, wherein using the machine learning-based technique, including the similarity function, includes using a feature-based decision tree in which features are associated with a profile relating to the first advertisement impression.

11. The method of claim 6, wherein the profile comprises characteristics associated with the first advertisement, characteristics associated with a Web page or property in association with which the first advertisement impression is to be served, and characteristics associated with a user to whom the first advertisement impression is to be served.

12. The method of claim 1, comprising training the model using at least a portion of the historical advertisement impression information and using a decision tree technique including the gradient boosting technique.

13. The method of claim 1, wherein using the similarity function comprises using a decision tree technique including the gradient boosting technique in nonlinearly, with respect to individual features, determining weighting of features.

14. The method of claim 1, comprising implementing bidding in accordance with the optimized bid.

15. The method of claim 1, comprising implementing bidding in accordance with the optimized bid through an online advertising exchange.

16. A system for use in an online advertising exchange, comprising
one or more server computers coupled to a network; and
one or more databases coupled to the one or more server computers;
wherein the one or more server computers are for:
obtaining a set of information comprising:
historical advertisement impression information associated with a set of previously served advertisement impressions, comprising profile information and revenue-related performance information;
forecasted revenue-related performance information relating to each of a set of possible advertisement impressions over a period of time; and
information relating to a first advertisement impression serving opportunity to be served during the period of time;
using at least a portion of the set of information, using a machine learning-based technique, comprising using a similarity function, in determining at least one advertisement impression of the set of possible advertisement impressions that is most similar to the first advertisement impression serving opportunity for a purpose of determining an optimized bid relating to the first advertisement impression serving opportunity, wherein weighting relating to advertisement features is determined in a nonlinear fashion relative to individual features;
determining an optimized bid relating to the first advertisement impression serving opportunity, based at least in part on forecasted revenue-related performance information relating to the at least one advertisement impression; and
storing optimized bid information relating to the optimized bid in at least one of the one or more databases.

17. The system of claim 16, wherein the network comprises the Internet.

18. The system of claim 16, comprising using a machine learning-based technique in determining importance weighting relating to advertisement features, in a nonlinear fashion relative to individual features, and comprising using the importance weighting as coefficients in terms of the similarity function.

19. A computer readable medium or media containing instructions for executing a method comprising:
using one or more computers, obtaining a set of information comprising:
historical advertisement impression information associated with a set of previously served advertisement impressions, comprising profile information and revenue-related performance information;
forecasted revenue-related performance information relating to each of a set of possible advertisement impressions over a period of time; and
information relating to a first advertisement impression serving opportunity to be served during the period of time;
using one or more computers and using at least a portion of the set of information, using a machine learning-based technique, comprising using a similarity function, in determining at least one advertisement impression of the set of possible advertisement impressions that is most similar to the first advertisement impression serving opportunity for a purpose of determining an optimized bid relating to the first advertisement impression serving opportunity, wherein weighting relating to advertisement features is determined in a nonlinear fashion relative to individual features and relates to importance in similarity analysis using the similarity function;
using one or more computers, determining an optimized bid relating to the first advertisement impression serving opportunity, based at least in part on forecasted revenue-related performance information relating to the at least one advertisement impression;
using one or more computers, storing optimized bid information relating to the optimized bid; and
using one or more computers, implementing bidding in accordance with the optimized bid.

20. The computer readable medium of claim 19, wherein the method comprises facilitating implementing bidding in accordance with the optimized bid on an online advertising exchange.
